(19) United States
(12) Patent Application Publication
(10) Pub. No.: US 2023/0068918 A1
(43) Pub. Date: Mar. 2, 2023

(54) CONTAINER LID AND BRUSH ASSEMBLY

(71) Applicant: Peter Manfredi, Rochester, NY (US)

(72) Inventor: Peter Manfredi, Rochester, NY (US)

(21) Appl. No.: 17/895,819

(22) Filed: Aug. 25, 2022

Related U.S. Application Data
(60) Provisional application No. 63/236,888, filed on Aug. 25, 2021.

(51) Int. Cl. B65D 51/32; B65D 43/02; A46B 17/00; A46B 5/00; B44D 3/12

(52) U.S. Cl. CPC B65D 51/32; B65D 43/0212; A46B 17/00; A46B 5/00; B44D 3/127; B65D 2543/00092; B65D 2543/00342; B65D 2543/00527; B65D 2543/00537; B65D 2543/00722; B65D 2543/00805; B65D 2543/0062; B65D 2543/00796; A46B 2200/202

(57) ABSTRACT

A container lid and brush assembly includes a lid having a body portion including an aperture passing from a topside of the body portion to an underneath side of the body portion. The lid is configured to seal an open top of a paint can and the aperture is configured to receive and secure a handle of a paint brush. The container lid assembly keeps the bristles of the paint brushed wetted during storage.

### RELATED APPLICATION

This is a Non-Provisional application claiming benefit to 63/236,888, filed on Aug. 25, 2021, which is incorporated by reference herein in its entirety.

### TECHNICAL FIELD

This disclosure relates to containers, including a replacement lid for paint cans and for holing paint brushes.

### DESCRIPTION OF THE RELATED ART

The size and shape of paint cans is generally standardized throughout the world. Standard paint cans include a lid that is removable to allow a paint brush to be dipped into the liquid paint contained within the can. Once wetted with paint, the paint brush is used to apply the paint to a structure such as a wall or ceiling.

When a painter using a can of paint and an associated paint brush wishes to take a break, he/she may typically reseal the can of paint using the lid and wash the paint from the brush. The can must be resealed to prevent the paint within the can from drying, and the brush must be washed to prevent the paint on the brush from hardening, thereby ruining the brush. This process is tedious and time consuming.

Accordingly, there is a need for a paint can replacement lid and brush assembly that both seals the paint can closed to prevent the paint within the can from drying, and that keeps the paint brush bristles wetted with paint within the can to prevent the bristles from hardening. The presently disclosed assembly addresses these needs.

### SUMMARY

In an embodiment, a container lid assembly includes a lid having a body portion including an aperture passing from a topside of the body portion to an underneath side of the body portion. The lid is configured to seal an open top of a paint can and the aperture is configured to receive and secure a handle of a paint brush.

### BRIEF DESCRIPTION OF THE DRAWINGS

Various other objects, features and attendant advantages of the present disclosure will become fully appreciated as the same becomes better understood when considered in conjunction with the accompanying drawings, in which like reference characters designate the same or similar parts throughout the several views, and wherein:

FIG. 1 shows a side view of a container lid and brush assembly consistent with an illustrative embodiment.

FIG. 2A shows a schematic of a container lid consistent with an illustrative embodiment.

FIG. 2B shows a side view of a container lid consistent with an illustrative embodiment.

FIG. 3A shows an aperture in the lid consistent with an illustrative embodiment.

FIG. 3B shows an aperture consistent with an illustrative embodiment.

FIG. 4A shows an aperture rim and an aperture cap consistent with an illustrative embodiment.

FIG. 4B shows an aperture cap consistent with an illustrative embodiment.

FIG. 5A shows an aperture and an aperture plug consistent with an illustrative embodiment.

FIG. 5B shows an aperture plug consistent with an illustrative embodiment.

FIG. 6 shows a brush assembly consistent with an illustrative embodiment.

FIG. 7 shows a container lid and brush assembly consistent with an illustrative embodiment.

FIG. 8 shows a brush assembly consistent with an illustrative embodiment.

FIG. 9 shows a container lid and brush assembly consistent with an illustrative embodiment.

FIG. 10 shows a container lid and brush assembly consistent with an illustrative embodiment.

FIG. 11 shows a container lid and brush assembly consistent with an illustrative embodiment.

### DETAILED DESCRIPTION

In general, and according to embodiments hereof, a container lid including a brush receptacle is provided. In some embodiments, the container lid includes a replacement lid that replaces a lid originally provided with a can of paint. For example, a can of paint may be purchased, and its lid may be removed and replaced with the container replacement lid described herein. The replacement lid includes a paint brush receptacle including an opening that passed from the topside of the lid to the bottom side of the lid. The opening is configured to receive a handle of a paint brush and to securely hold the paint brush in an upright orientation with its bristles facing downward. With the replacement lid placed over the top opening of the can of paint and the paint brush held within the opening, the bristles of the paint brush extend downward into the liquid paint held within the can. Thus, the can is sealed by the replacement lid and the paint brush bristles, being submerged into the paint, remain wetted.

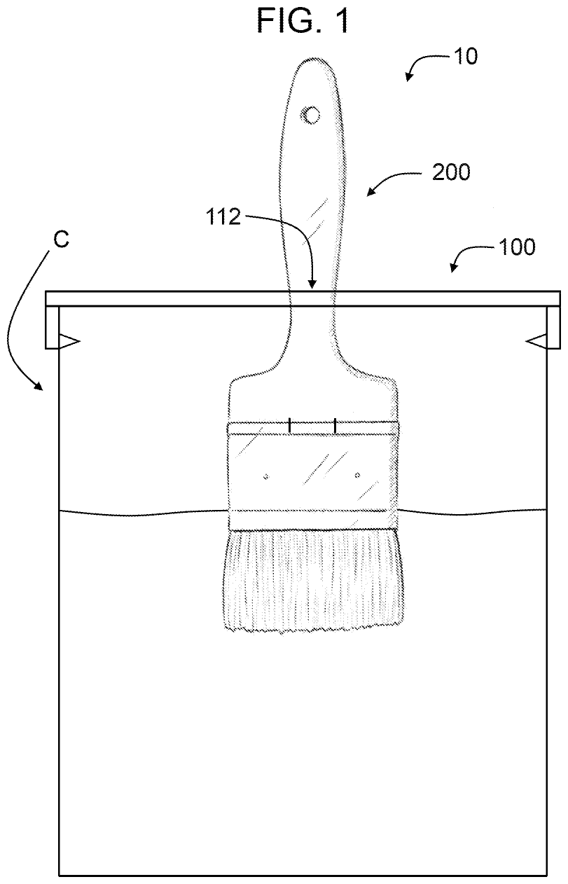

In one embodiment hereof, as shown in FIG. 1, the container lid and brush assembly 10 includes a lid assembly 100, and a brush assembly 200. The brush assembly may be optional. In other words, the user may supply their own brush that is interested into the lid assembly 100. In general, the lid assembly 100 includes a replacement lid for a can C (e.g., a paint can), and the brush assembly 200 includes a brush specifically designed to be used with the lid assembly 100. Notably, while the lid assembly 100 and the brush assembly 200 will be described with respect to using the assemblies 100, 200 together, the lid assembly 100 may be used independently of the brush assembly 200, and the brush assembly 200 may be used independently of the lid assembly 100. The container lid and brush assembly 10 also may include other elements and/or components as necessary to perform its functionalities.

For the purposes of this description, the container lid and brush assembly 10 will be described with respect to its use with a paint can C containing a volume of liquid paint. However, it is understood that the container lid and brush assembly 10 may be used with other types of containers holding various types of liquids, and that the scope of the assembly 10 is not limited in any way by the type(s) of container(s) that it may be used with.

### Lid Assembly 100

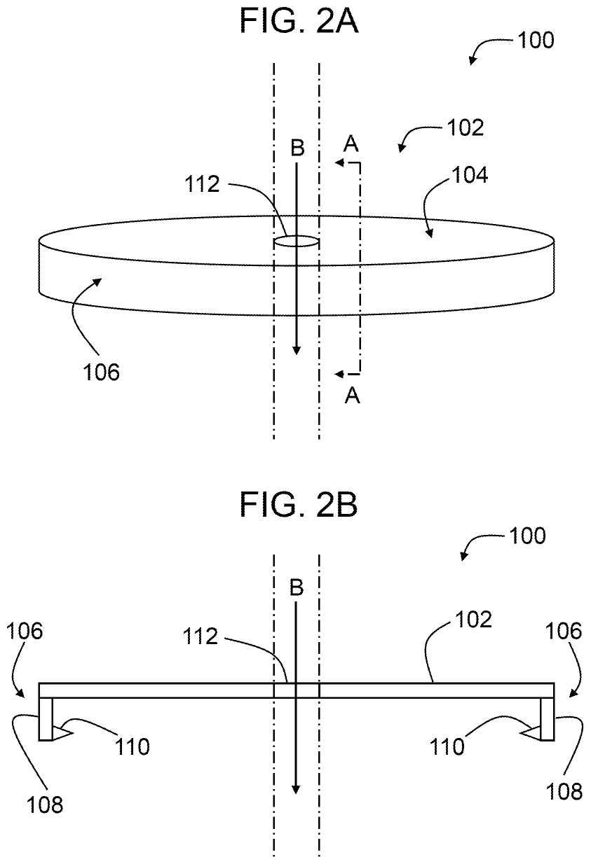

In some embodiments such as shown in FIGS. 2A-2B, the lid assembly 100 includes a lid 102 designed to cover and seal an open top of a container, e.g., the open top of a paint can. The lid 102 includes a body portion 104 and an attachment portion 106. The body portion 104 is formed as a generally flat plate member configured to completely cover the top opening of a paint can. Accordingly, the outer circumference of the body portion 104 is preferably shaped to correspond to the circumferential shape of the top of the can of which it will cover. For example, if the can includes a circular top opening then the body portion 104 may also be circular. Other shapes also may be used. It also is contemplated that the body portion 104 may include curvatures or other forms and may not be completely flat. For example, the body portion 104 may be conically-shaped.

The attachment portion 106 includes mechanisms designed to attach the body portion 104 to the top of the can. In some embodiments, the attachment of the body portion to the top of the can forms an airtight arrangement. For example, in some embodiments, the attachment portion 106 includes a standardized paint can lid attachment mechanisms found on standard paint can lids as known in the art, such as, e.g., pressure fit circumferential rims. In other embodiments, the attachment portion 106 includes attachment mechanisms designed to facilitate an easy attachment and subsequent removal of the lid 102 onto and off of the can. For example, in some embodiments such as shown in FIG. 2B (taken from the perspective of cutlines A-A in FIG. 2A), the attachment portion 106 includes a downward pointing lip 108 about the outer circumference of the body portion 104 (or at least a portion thereof) configured to overlap an outer circumference of the top of a can.

In some embodiments such as shown in FIG. 2B, the attachment portion 106 may include an inward facing circumferential tab 110 coupled to the inner side wall of the downward pointing lip 108. The inward facing tab 110 is configured to engage one or more outer circumferential ridges that may exist about the top of a standard paint can.

In use, the lid 102 is placed over the top of the can with the lid body 104 covering the can's top opening and the downward pointing lip 108 extending downward circumferentially over the can's sides (see FIG. 1). In this configuration, the inward facing circumferential tab 110 may engage a top outer circumferential ridge on the can (e.g., as a detent mechanism). Once engaged, the inward facing circumferential tab 110 may secure the lid 102 in place.

In other embodiments, the downward pointing lip 108 and/or the inward facing circumferential tab 110 may engage the upper sides of the can by being pressure fit to secure the lid 102 to the paint can.

Regardless of the type(s) of attachment mechanisms 106 used, it is understood that the lid 102 is designed to provide an airtight seal to the top opening of the can C (see FIG. 1). It also is understood that the attachment mechanisms 106 and the attachment methodologies described herein are meant for demonstration and that the lid assembly 100 may include any type of attachment mechanisms 106 to secure the lid 102 over the top opening of the can in a sealed and airtight arrangement.

In some embodiments such as shown in FIGS. 2A-2B, the body portion 104 includes an aperture 112 passing from the lid's 102's topside to the lid's 102's underneath side (as represented by the arrow B). As will be described in other sections, the aperture 112 is configured to receive and securely hold the handle of a paint brush (e.g., the handle 204 of a paint brush assembly 200 as shown in FIG. 1).

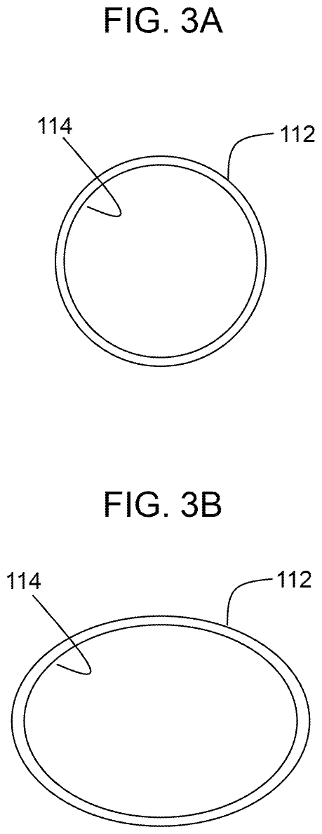

In some embodiments such as shown in FIG. 3A, the aperture 112 includes a circular circumferential shape, while in other embodiments such as shown in FIG. 3B, the aperture 112 includes an oval circumferential shape. It is understood that the aperture 112 may include any circumferential shape as required (e.g., as required to secure a handle of a paint brush) and that the scope of the assembly 10 is not limited in any way by the shape of the aperture 112.

In some embodiments such as shown in FIGS. 3A-3B, the aperture 112 includes a sealing layer 114 coupled to its inner side walls. The sealing layer 114 is formed to provide an airtight and liquid-tight seal around a paint brush handle when the paint brush handle is received and held within the aperture 112 (as shown in FIG. 1). The sealing layer 114 may include rubber, foam, epoxy, plastic, other types of sealing materials, and any combinations thereof. Some pressure may be applied to the brush handle to insert a paint brush into the aperture 112.

The lid body 104, the aperture 112, and/or the sealing layer 114 may be pliable to allow the insertion and subsequent securing of a paint brush handle. For example, it is preferable that the aperture 112 and/or the sealing layer 114 expand to allow the insertion of the paint brush handle into the aperture 112, and subsequently close about the paint brush handle to secure the handle therein. This construction will be described in further detail in other sections.

As shown in FIG. 1, the lid assembly 100 may be configured with the top of the can C, and the handle of a paint brush (e.g., the handle of the brush assembly 200) received and held within the lid's aperture 112, that the container lid and brush assembly 10 provide an airtight seal to the top opening of the can C.

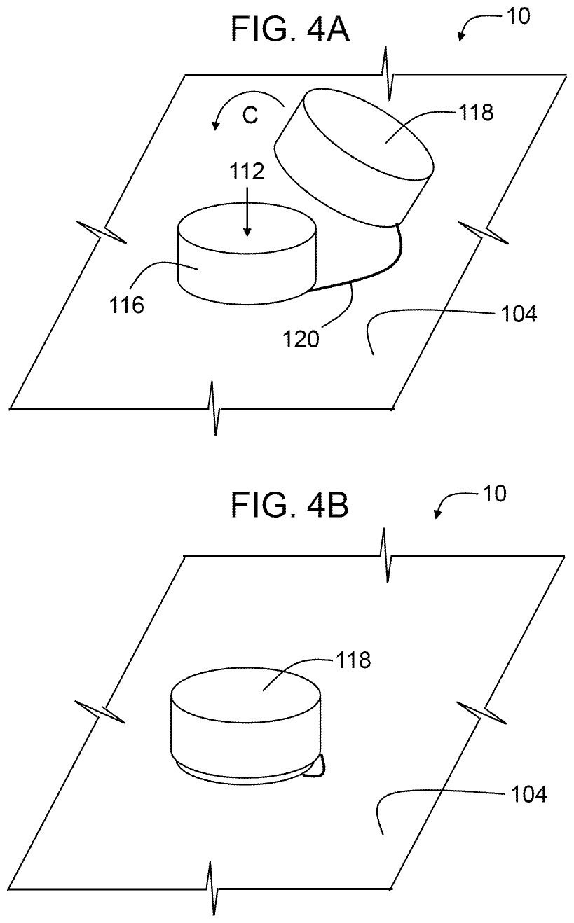

In some embodiments such as shown in FIGS. 4A-4B, the lid assembly 100 includes an aperture closure mechanism. For example, in some embodiments, the lid assembly includes an aperture rim 116 extending upward about the circumference of the aperture 112, and an aperture cap 118 configured to cover the aperture rim 116 in an airtight arrangement. The cap 118 may be placed over the aperture rim 116 by aligning the cap 118 with the aperture rim 116 (e.g., by moving the cap 118 in the direction of arrow C in FIG. 4A), resulting in the arrangement shown in FIG. 4B. The cap 118 may be held in place by pressure fit, detents, or other types of attachment mechanisms and may be secured to the assembly 10 using a cap tether 120 as desired. The cap 118 may be removed from the aperture rim 116 by lifting the cap 118 upward.

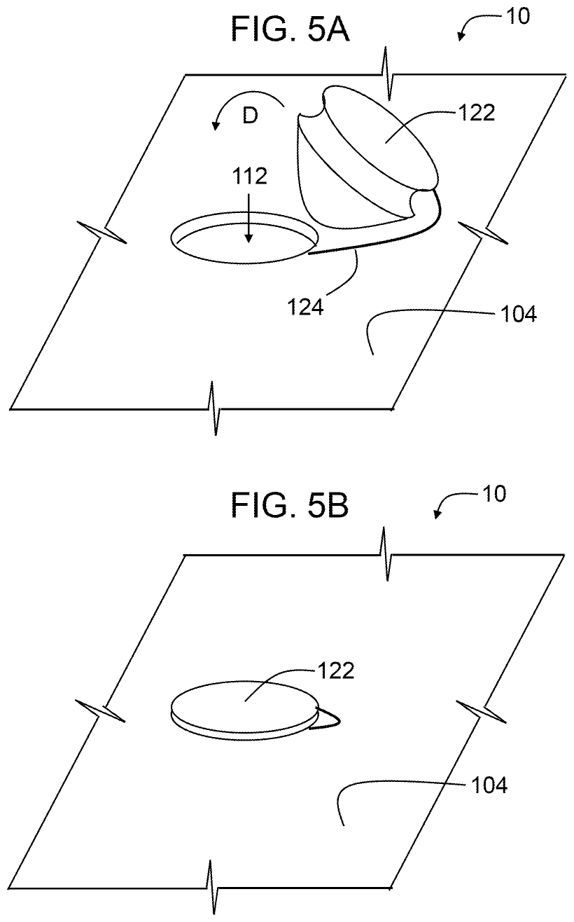

In some embodiments such as shown in FIGS. 5A-5B, the lid assembly 100 includes an aperture plug 122 configured to plug into the aperture 112 and seal it in an airtight arrangement. The plug 122 may be placed into the aperture 112 by aligning the plug 122 with the aperture 112 (e.g., by moving the plug 122 in the direction of arrow D in FIG. 5A), resulting in the arrangement shown in FIG. 5B. The plug 122 may be removed from the aperture 112 by lifting the plug 122 upward. The plug 122 may be secured to the assembly 10 using a plug tether 124, but this may not be necessary.

The cap 118 and/or the plug 122 may be used to seal the aperture 112 when a brush assembly 200 is not configured with the aperture 112 and may be removed from the aperture 112 when it is desired to place a brush assembly within the aperture 112. Other types of aperture closure mechanisms are contemplated as known in the art.

### Brush Assembly 200

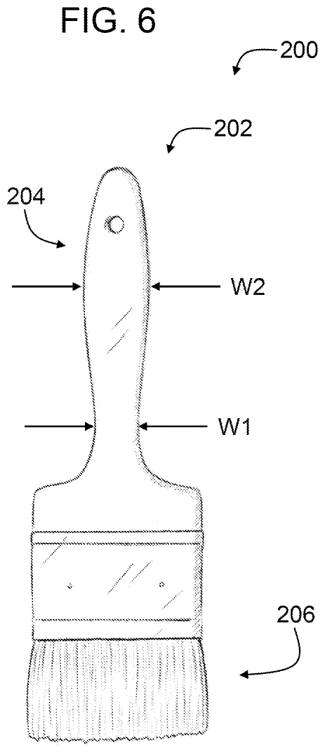

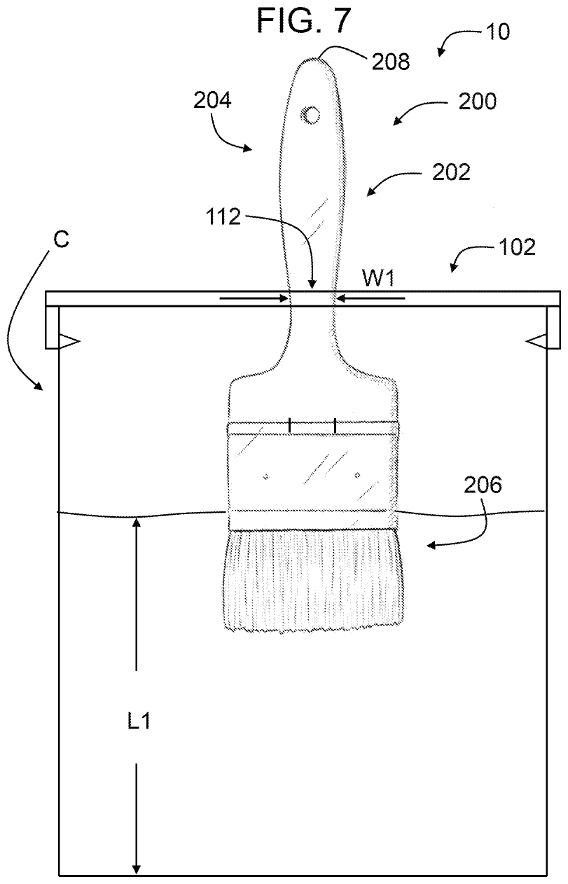

In some embodiments such as shown in FIG. 6, the brush assembly 200 includes a brush 202 including an elongate handle 204 and a bristle portion 206. In some embodiments, the elongate handle 204 includes a top 208 (as shown in FIG. 7) (opposite the bristle portion 206) and two or more distinct widths at two or more distinct locations along the handle 204. For example, the handle 204 may include a first width W1 at a lower location and a second width W2 at an upper location as shown. In this embodiment, the first width W1 is less than the second width W2. It is to be understood that the brush assembly 200 may be optional, as in some embodiments the lid 102 may be provided and a user inserts their own paint brush through the aperture 112.

In some embodiments such as shown in FIG. 7, to configure the brush 202 with the lid 102, the top 208 of the elongate handle 204 is pressed through the lid's 102's aperture 112 from underneath. As the length of the handle 204 moves through the aperture 112, the aperture 112 and/or the sealing layer 114 expand to accommodate the handle's second width W2. As the length of the handle 204 continues to pass through the aperture 112, the aperture 112 and/or the sealing layer 114 contract until the location of the first width W1 is generally aligned with the aperture 112. In this position, it is preferable that the aperture 112 and/or the sealing layer 114 form an airtight seal around the handle 204 while holding the handle 204 securely in place. This results in the configuration shown in FIG. 7.

With continued reference to FIG. 7, the level of the liquid paint (depicted by L1) is such that the bristle portion 206 of the brush 202 is fully submerged within the paint. By submerging the brush within the paint, the bristle portion 206 may remain wetted when the assembly 10 is used to seal the top of the can C.

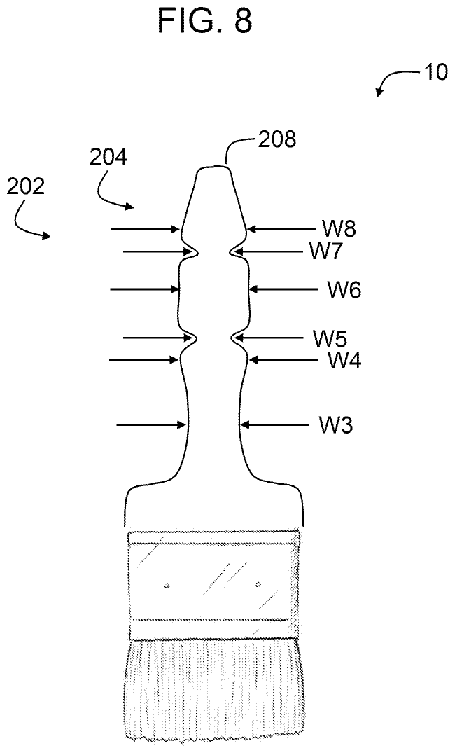

In some embodiments, the brush handle 204 includes alternating sections of narrow widths and larger widths. For example, as shown in FIG. 8 and starting at a lower portion of the handle 204 and moving upward, the brush handle 204 includes a first section of width W3 followed by a second section of width W4 (with W4>W3), followed by a third section of width W5 (with W5<W4), followed by a fourth section of width W6 (with W6>W5), followed by a fifth section of width W7 (with W7<W6), and followed by a sixth section of width W8 (with W8>W7). Accordingly, the brush 202 may be positioned within the aperture 112 at different vertical positions depending on which narrow width (e.g., W3, W5, or W7) is aligned with the aperture 112 and held thereby.

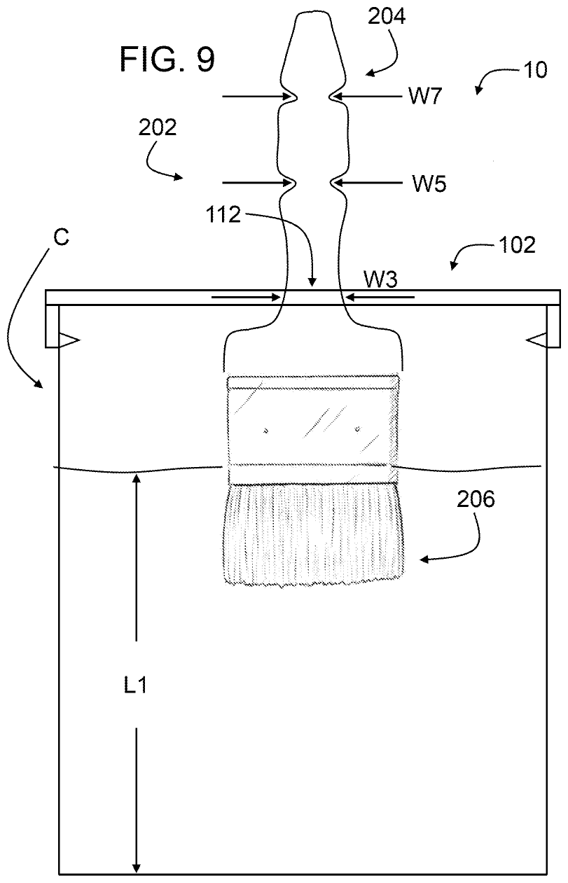

For example, as shown in FIG. 9, with the liquid paint within the can C at a level L1, the brush handle 204 may be positioned within the aperture 112 by aligning its width W3 with the aperture 112. This may result in the brush's 202's bristle portion 206 (and not the brush's 202's handle 204) being submerged within the liquid paint.

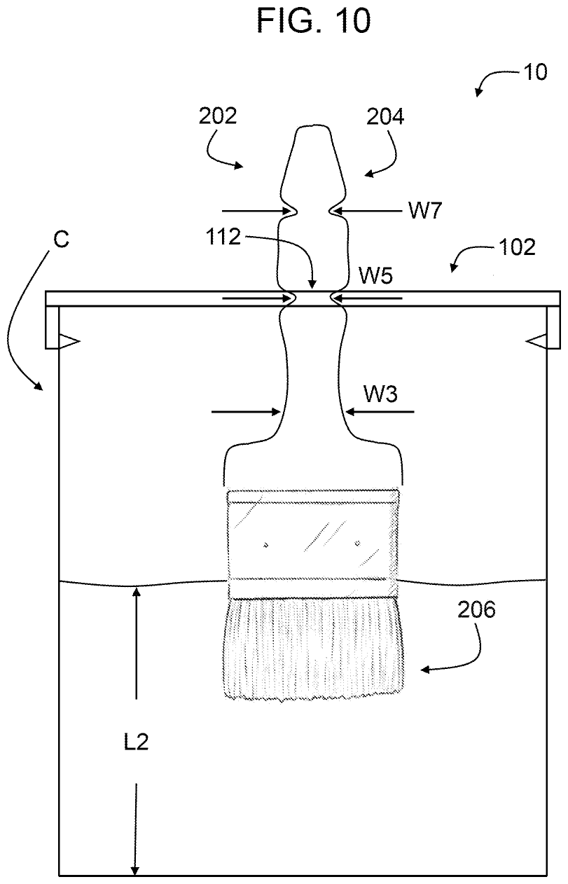

In another example such as shown in FIG. 10, with the liquid paint within the can C at a lower level L2 (with L2<L1), the brush handle 202 may be positioned within the aperture 112 by aligning its width W5 with the aperture 112. Accordingly, the brush 202 is lowered further into the can C so that the brush's 202's bristle portion 206 remains submerged within the liquid paint at the lower level L2.

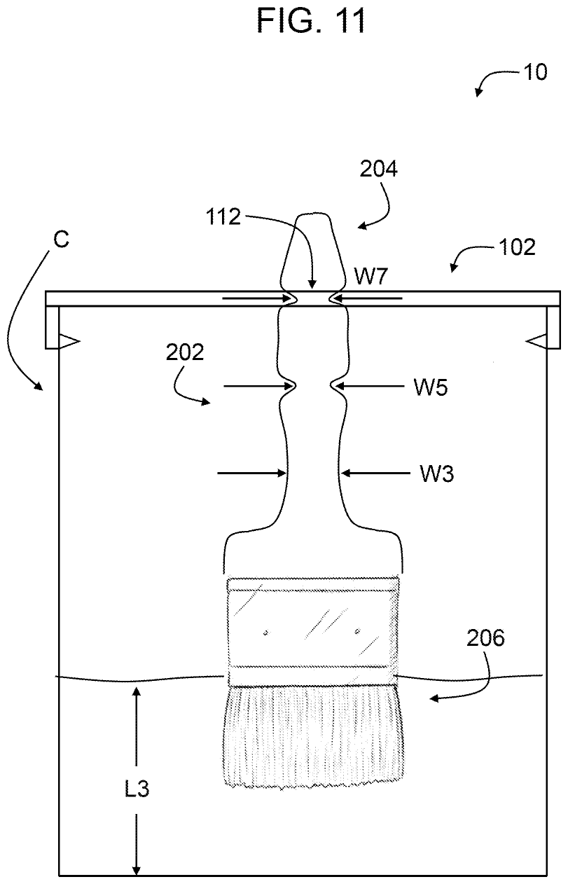

In yet another example such as shown in FIG. 11, with the liquid paint within the can C at a further lower level L3 (with L3<L2<L1), the brush handle 202 may be positioned within the aperture 112 by aligning its width W7 with the aperture 112. Accordingly, the brush 202 is lowered further into the can C so that the brush's 202's bristle portion 206 remains submerged within the liquid paint at the lower level L3.

While three narrow widths W3, W5, W7 and three wider widths W4, W6, W8 are depicted in FIGS. 8-11, it is understood that any number of narrow widths and/or wider widths may be used to set the brush handle 204 at various heights within the aperture 112 depending on the level of the liquid paint within the can C.

It is understood that any aspect and/or element of any embodiment of the assembly 10 described herein or otherwise may be combined in any way with any other aspect and/or element of any other embodiment to form additional embodiments of the assembly 10 all of which are within the scope of the assembly 10. It is also to be understood while the embodiments shown and described herein contemplate the continued use of a paint can provided with the purchase of the paint, the container lid assembly may be provided with an optional replacement can that can stored the unused paint with a lid ND brush inserted as discussed herein above with some embodiments of the present disclosure.

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used in this description, the term “portion” means some or all. So, for example, “A portion of X” may include some of “X” or all of “X”. In the context of a conversation, the term “portion” means some or all of the conversation.

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first,” “second,” and so on, in the description and claims, are used to distinguish or identify, and not to show a serial or numerical limitation. Similarly, letter labels (e.g., “(A)”, “(B)”, “(C)”, and so on, or “(a)”, “(b)”, and so on) and/or numbers (e.g., “(i)”, “(ii)”, and so on) are used to assist in readability and to help distinguish and/or identify, and are not intended to be otherwise limiting or to impose or imply any serial or numerical limitations or orderings. Similarly, words such as “particular,” “specific,” “certain,” and “given,” in the description and claims, if used, are to distinguish or identify, and are not intended to be otherwise limiting.

As used herein, including in the claims, the terms “multiple” and “plurality” mean “two or more,” and include the case of “two.” Thus, e.g., the phrase “multiple ABCs,” means “two or more ABCs,” and includes “two ABCs.” Similarly, e.g., the phrase “multiple PQRs,” means “two or more PQRs,” and includes “two PQRs.”

The present disclosure also covers the exact terms, features, values and ranges, etc. in case these terms, features, values and ranges etc. are used in conjunction with terms such as about, around, generally, substantially, essentially, at least etc. (i.e., “about 3” or “approximately 3” shall also cover exactly 3 or “substantially constant” shall also cover exactly constant).

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components unless specifically so stated.

It will be appreciated that variations to the embodiments of the disclosure can be made while still falling within the scope of the disclosure. Alternative features serving the same, equivalent or similar purpose can replace features disclosed in the specification, unless stated otherwise. Thus, unless stated otherwise, each feature disclosed represents one example of a generic series of equivalent or similar features.

The present disclosure also covers the exact terms, features, values and ranges, etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” (“e.g.,”) and the like, is merely intended to better illustrate the disclosure and does not indicate a limitation on the scope of the disclosure unless specifically so claimed.

While the disclosure has been described in connection with what is presently considered to be the most practical embodiments thereof, it is to be understood that the disclosure is not to be limited to the disclosed embodiment, but on the contrary, is intended to cover various modifications and equivalent arrangements included within the spirit and scope of the appended claims.

1. A container lid assembly, comprising:
a lid including a body portion including an aperture passing from a topside of the body portion to an underneath side of the body portion;
wherein the lid is configured to seal an opening of a paint can, and
wherein the aperture is configured to receive and secure a handle of a paint brush.

2. The container lid assembly of claim 1, further comprising an aperture closing mechanism configured to seal the aperture in an airtight arrangement.

3. The container lid assembly of claim 1, wherein the lid includes a body portion comprising a substantially flat plate member configured to cover the opening of a paint can.

4. The container lid assembly of claim 3, further comprising an attachment portion configured to attach the body portion to a top of a paint can.

5. The container lid assembly of claim 4, wherein the attachment portion comprises a pressure fit circumferential rim, and
the lid includes an aperture rim extending upward about a circumference of the aperture, and an aperture cap configured to cover the aperture rim.

6. The container lid assembly of claim 5, wherein the pressure fit circumferential rim forms an airtight seal with the opening of the paint can.

7. The container lid assembly of claim 4, wherein the attachment portion is configured to overlap an outer circumference of the top of the paint can.

8. The container lid assembly of claim 4, wherein the attachment portion includes a downward pointing lip extending from at least a portion of an outer circumference of the body portion of the lid assembly.

9. The container lid assembly of claim 8, wherein the attachment portion comprises an inward facing tab coupled to the inner side wall of the downward pointing lip.

10. The container lid assembly of claim 9, wherein the inward facing tab is configured to engage with one or more outer circumferential ridges along the top of the paint can.

11. The container lid assembly of claim 9, wherein the inward facing tab is configured to engage with an upper side of the can by pressure fitting.

12. The container lid assembly of claim 9, wherein the downward pointing lip is configured to engage with an upper side of the can by pressure fitting.

13. The container lid assembly of claim 4, wherein the body portion includes an aperture passing from the a topside of the lid to an underneath side.

14. The container lid assembly of claim 13, wherein the aperture is configured to receive and securely hold a handle of a paint brush.

15. The container assembly of claim 14, wherein the aperture is defined in a sealing layer 114 coupled to its inner side of the lid walls.

16. A brush assembly, comprising:
a brush including an elongate handle and a bristle portion; and
wherein the brush is configured for insertion into an aperture formed in a lid of a paint can.

17. The brush assembly according to claim 16, wherein the elongate handle includes a series of notches configured to engage the brush with edges of the aperture formed in the lid of the paint can at particular predetermined position in the aperture of a plurality a predetermined positions.

18. The brush assembly according to claim 16, wherein the elongate handle includes a top portion opposite the bristle portion of the brush, and having two or more distinct widths at two or more distinct locations along the elongate handle.

19. The brush assembly according to claim 18, wherein two or more distinct widths of the elongate handle includes a first width W1 at a lower location and a second width W2 at an upper location of the handle, and
wherein the first width W1 is less than the second width W2.

20. A container lid and brush assembly, comprising:
a lid including a body portion including an aperture passing from a topside of the body portion to an underneath side of the body portion;
an aperture rim extending upward about a circumference of the aperture, and an aperture cap configured to cover the aperture rim; and
a brush including an elongate handle and a bristle portion;
wherein the brush is configured for insertion into the aperture formed in the body portion of the lid, and
wherein the lid is configured to seal an opening of a can, and
wherein the aperture is configured to receive and secure the elongate handle of the brush.
